(19) United States
(12) Patent Application Publication
(10) Pub. No.: US 2022/0188585 A1
(43) Pub. Date: Jun. 16, 2022

(54) Colored Triangle Barcode

(71) Applicant: Adam Melhem, Kafr Yasif (IL)

(72) Inventor: Adam Melhem, Kafr Yasif (IL)

(21) Appl. No.: 17/122,010

(22) Filed: Dec. 15, 2020

(51) Int. Cl. G06K 19/06; G06K 7/12

(52) U.S. Cl. CPC G06K 19/0614; G06K 7/12

(57) ABSTRACT

The invention relates to Storing data in a form of compressed codded colored triangles barcode in electronic devices and nonelectronic surfaces (e.g., papers, encrypted jpg files, temporary stored in ram CPU memory to be displayed on device screen), to store the data in compact compressed way and to be retrieved and transmitted using electronic cameras or transmitted in the form of colors triangles Barcode to remote devices or electronic storages for example by sending the colored triangles data codded data by email or stored on USB disk on key device.

### BACKGROUND

The invention relates to

Storing data in a form of compressed codded colored triangles barcode in electronic devices and none electronic surfaces (e.g., papers, encrypted jpg files, temporary stored in ram cpu memory to be displayed on device screen)

This to store the data in compact compressed way and to be retrieved and transmitted using electronic cameras or transmitted in the form of colors triangles Barcode to remote devices or electronic storages for example by sending the colored triangles data codded data by email or stored on USB disk on key device infected with a computer virus.

The specification explains the need for computer systems to stored data in compressed visual form to reduced the data stored space medium and make the data visually accessible more easily.

The disclosed invention operates by physically storing the data in the form of colored triangles (eg, printed on paper, or in physical device memory as an jpg image file), the it is possible to read the data and decode it by taking screen shot of the colored triangles and decode the compressed data back to its original electronic data form (binary data).

The same method can be used to perform data streaming from one screen device to other device through its camera, to transfer the data in the form of colored triangles in the screen side and decoded back to data in the receiving device in synchronized data transfer session.

The data parsing and converting it to colored triangles routine performs the following operations:

1. Iterates over each three bytes of data (24 bits), and convert them into RGB color (24-bit color that consists of the components Red (256 bit), Green (256 bit), Blue (256 bit).

2. Then store each RGB generated color in the form of triangle draw image, where in the middle the RGB color and his perimeter consist of three equal sides where each side has one of the three colors, Red Or Green Or Blue, yet the three sides must have different colors, in other words in the middle of the triangle we have the RGB previous step generated RGB color code, and one triangle side with red color and another side of the triangle with green color and another side of the triangle with the color of blue.

3. continue iterating over three bytes of the data and convert those into Colored Triangle which its middle is the RGB generated color and consist of three equal sides of red, green and blue until no further data still need to be coded in the overall data.

4. Store the overall generated colored triangles draws in sequence from left to right as one draw consist of colored triangles Barcode in one draw image.

The colored triangles parsing and converting it to back to its original data routine performs the following operations:
1. A camera photo or screen shot is taken to the displayed colored sequence of triangles Barcode image.
2. Iterate over each colored triangle from left to right and convert it back to 24 bit of data, by retrieving the original three colors components of the RGB color that the RGB color consists of, and thus been done diffusing the RGB color that is in the middle of the triangle against the red side color of the triangle and the outcome value would represent the first byte out of the three bytes of data, then diffusing the RGB color that is in the middle of the triangle against the green side color of the triangle and the outcome value would represent the second byte out of the three bytes of data, then diffusing the RGB color that is in the middle of the triangle against the blue side color of the triangle and the outcome value would represent the third byte out of the three bytes of data.
3. continue iterating over the colored triangles in the Barcode draw image until no further colored triangles draws still need to be decoded in the overall codded data.

[symbol]

[symbol]

What is claimed is:

1. A method and system of storing data in form of compressed coded colored triangles barcode in electronic devices and non-electronic surfaces (e.g., papers, encrypted jpg files, temporary stored in RAM CPU memory in order to be displayed on the screen of the concerned device) with a feature of taking snap or screen of the displayed colored sequence of triangular barcode image;

2. The invention as claimed in claim 1 will comprise the functionality of iterating over each colored triangle from left to right then convert it back to 24 bit data via the method of retrieving the original three color components of the RGB color that the RGB color consists of and diffuse the RGB color in the middle of the triangle against the red color side of the triangle; the outcome value would represent the second byte amongst the three byte data and then diffuse the RGB color that is in the middle of the triangle against the blue side color of the triangle resulting in the outcome which would represent the third byte out of the three bytes of the data.

3. The functionality of iterating as claimed in claim 2 shall continue iterating over the colored triangles in the Barcode draw image until no further colored triangles draws still need to be decoded in the overall coded data.
